(19) United States
(12) Patent Application Publication
(10) Pub. No.: US 2007/0210069 A1
(43) Pub. Date: Sep. 13, 2007

(54) Gas cooker appliance with an orientable control panel

(75) Inventor: Inigo Albizuri, Guadalajara (Jalisco) (MX)

Correspondence Address: THE KLINE LAW FIRM, PC., 161 Little Pond Lane, Palmyra, VA, 22963, US

(73) Assignee: COPRECITEC, S.L., Aretxabaleta (Guipuzcoa) (ES)

(21) Appl. No.: 11/604,078

(22) Filed: Nov. 24, 2006

(30) Foreign Application Priority Data
Mar. 3, 2006 (ES) U-200600514

(51) Int. Cl. H05B 1/02

(52) U.S. Cl. 219/501

(57) ABSTRACT

The cooker appliance (1) has a horizontal cooking surface (10) of a given height (Hw), a gas “G” manifold assembly (2) with a plurality of taps (8) provided with a rotary shaft (9) for regulating the gas flow (Q), supported in a fixed position apart from one another on a front support wall (11) and at a given height (Hv) of the appliance. The control panel (3) provided with each of the rotary tap control knobs (4) is orientable up to as much as a right angle (A) by means of a pivoting axle (6), whereby the control knobs (4) are positioned either downwards in a rest position or else upwards at the level of the cooking plane (10) for the regulating manoeuvre, on a horizontal plane (P) at an increased height “Hv+Hv”. The control knob shafts (7) are coupled to the taps (8) by means of a flexible shaft (5) for transmitting the respective rotation, extended within a cavity (3a) for housing the taps (8) which is formed by the control panel.

### TECHNICAL FIELD

The present invention relates to an arrangement of the panel for the control of the gaseous fuel on a household cooker appliance.

### PRIOR ART

Gas cooker appliances are already known that are provided with a gas distributing conduit with a number of regulating taps fixed to the frame of the appliance and a control panel fixed to an outer support wall on the appliance, at a height from the floor suitable for operating the control knobs. Likewise known is a cooker appliance provided with a gaseous fuel manifold assembly fixed to the frame of the appliance, wherein each tap is set apart from its respective control knob. On these cooker appliances each of the knobs has a rotary shaft coupled to a means for transmission of the rotation for regulating the gas flow supplied by the respective tap. Said transmission means is a shaft of variable length but articulated and rigid, since the control panel is fixed and always remains in the same position relative to each tap. Cooker appliances whose control panel is situated during cooking on a horizontal plane adjacent to the cooking surface or working plane have the drawback of being exposed to the entry of dirt and spillages from the cooking surface. The arrangement of the control panel away from the cooking surface has the disadvantage of its low height, inconvenient for operation of the control knobs by the user.

### DISCLOSURE OF THE INVENTION

The object of the invention is a gas cooker appliance that has an orientable control knob panel for changing the position of the knobs to a horizontal operating plane of greater height relative to the cooking surface or working plane.

The gas cooker appliance according to the invention comprises a control panel with a plurality of rotary knobs for actuating the respective regulating taps, which is situated in a rest position on an outer support wall on the appliance at a given height, and it has a horizontal pivoting axle fixed on an outer wall on the frame of the appliance, so that the control panel is capable of pivoting through as much as a right angle until situating the control knobs at a greater height for an easier rotation manoeuvre, and then to return it to its rest position after the regulating manoeuvre. The rotation of each control knob is transmitted to the respective gas tap regulating shaft by means of a flexible transmission shaft the length and form of which is appropriate to the angular movement of the panel during pivoting.

On the cooker appliance of the invention an orientable control panel is achieved which provides a greater height for the panel knobs and a vertical arrangement of the rotary knob shafts, thereby the action of opening and adjusting each tap for the user, but returned to the rest position after the regulating manoeuvre without the risk of the spills and dirt entering the interior of the panel.

### DESCRIPTION OF THE DRAWINGS

FIG. 1 is a profile view of a gas cooker appliance with a control panel oriented upwards for its operation.

### DETAILED DESCRIPTION OF THE INVENTION

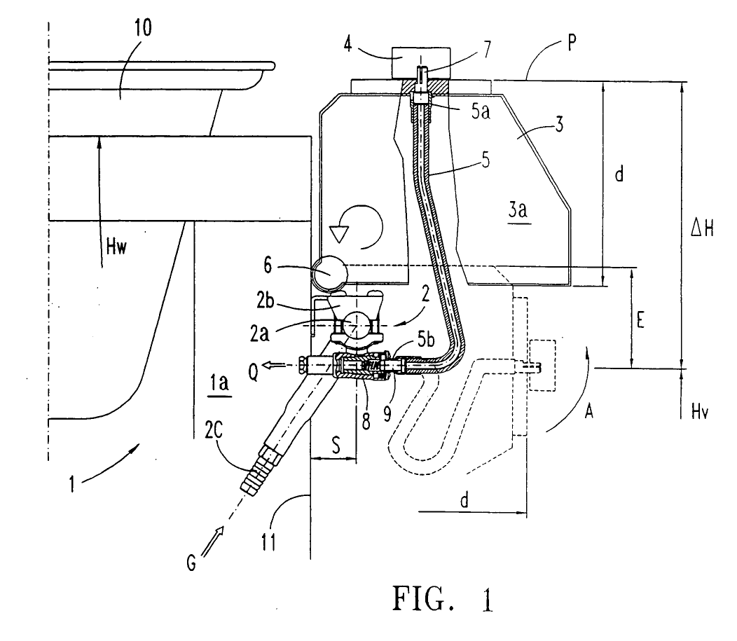

In reference to FIG. 1, a preferred embodiment of the cooker appliance 1 comprises an appliance frame la formed of a cooking surface or plane 10 of working height Hw, for instance an uncovered grill plate, and various support walls, a front gas manifold assembly 2 fixed to an installation support wall 11 on the frame by means of a mounting bracket 2b, and a control panel 3 provided with a number of rotary knobs 4 for regulating the gas flow “Q”.

The gas manifold assembly 2 comprises a conduit 2a for distributing the gaseous fuel “G” of the cooker appliance 1, a plurality of taps 3 mounted apart from one another and in a fixed position in relation to said front mounting panel 1, and a cooker gaseous fuel “G” supply nipple. Each of the gas taps 8 is provided with a rotary shaft 9 for regulating a flow “Q” supplied by each tap to the cooking surface 10, oriented horizontally towards the exterior of the appliance, and positioned at a height “Hv” of the frame 1a below the cooking surface 10.

The rotary knobs 4 are mounted on the control panel 3, with the respective transverse control shaft 7 lodged in a hollow cavity 3a in the control panel 3, which is formed with a housing depth “d”. This control panel 3 is provided with a horizontal pivoting shaft 6 preferably mounted on an outer support wall on the frame, at a height “E+Hv” greater than the height “Hv” of the tap shafts 9.

On two different cooker appliance models, on one of them the outer support wall 11, having supported the control panel 3, comprises a vertical front wall 11 of the cooker appliance 1, or on the other appliance model the control panel 3 is supported on a horizontal wall (not shown in the figures) adjacent to the cooking surface 10, the control panel 3 being situated in both cases in a vertical orientation in the initial rest position (shown in dotted lines in FIG. 1), that is to say with the control shafts 7 horizontal, while in the panel 3 operating position P after a pivoting action A of 90°, the control shafts 7 are vertical.

The gas manifold assembly 2 with the taps 8 is set a space “S” apart from said front wall 11 by means of said mounting bracket 2b. The hollow cavity 3a in the control panel 3 is constructed for the housing of the manifold assembly 2, the tap shafts 9 and of a shaft 5 for transmitting the rotation of each control knob 4 coupled to the respective tap 8. In the panel rest position, the control 4 with its shaft 7 is oriented horizontally at a height relative to the frame 1a, equivalent to the height Hv of the tap shaft 9, the flexible shaft 5 keeping a folded form within the panel cavity 3a. In the panel rest position, by means of the cavity 3a the rotary control knobs 4 are set a given space apart from said manifold assembly mounting wall 11, in correspondence with the housing depth “d”, which determines once the pivotation of the control panel (3) is carried out, the increase in height “Hv” of the rotary control knobs 4.

The control panel 3 is capable of pivoting through a right angle “A” around the pivoting axle 6, from an initial rest position to a second horizontal position “P” for operating the knobs 4. In the latter position, the knob shafts 7 are disposed vertically and at an advantageous height Hv+H for the manoeuvre greater than the height Hv in the rest position of the control panel 3. The transmission means 5 is constructed with a flexible cable 5 provided with two terminals 5a, 5b for their respective coupling to the knob 4 and to the respective tap 8, the plurality of flexible shafts 5 remaining extended due to the greater separating distance resulting between the knob 4 and the tap 8 when the control panel 3 is pivoted for carrying out the tap actuating rotation.

What is claimed is:

1. A cooker appliance (1) provided with a plurality of taps (8) for regulating an individual gas flow (Q) supplied to a horizontal cooking surface (10) situated at a given height (Hw), comprising:
a cooker appliance frame (1a) further formed by various walls (11) for supporting the appliance, on a front support wall (11) of which there is a gaseous fuel “G” manifold assembly attached that includes a plurality of taps (8) mounted apart from one another, each of them either aligned or grouped in a fixed position relative to said front wall (11) at a given height (Hv) in respect of said cooking surface (10).
wherein each tap (8) is provided with a rotary shaft (9) for regulating said individual flow (Q),
a control panel with the rotary control knobs (3) for actuating a respective gas tap (8), attached to the control panel apart from one another and maintaining a relative height position in respect of the height (Hv) of the taps (8) mounted on said front wall (11).
a means (5) of transmitting the rotation from each of the knobs (4) to a rotary actuating shaft (9) of a respective tap.
the control panel (3) being orientable by means of a change of angular position relative to the appliance frame (1a) around a horizontal pivoting shaft (6) supported on said frame (1a) parallel to said outer support wall (11) and positioned at a height (Hv+E) above the taps (8), and
said transmission means (5) comprising a flexible shaft (5) coupled by a respective terminal (5a,5b) to the rotary knob (4) and to the rotary shaft (9) of the tap,
whereby the control panel (3) is capable of pivoting through up to a right angle (A) for its orientation from an initial rest position to a second horizontal position (P) for the manoeuvre of regulating each tap, in which the control shafts (7) maintains a vertical orientation, and it is kept at a height (Hv+H) relative to the cooking surface (10) substantially greater than the height (Hv) of the tap shaft (9).

2. The gas cooker appliance (1) with a control panel (3) according to claim 1, wherein the control panel (3) is formed with a cavity (3a) for housing the manifold assembly (2), including the regulating taps (8) and the flexible rotation transmission shafts (5), which id keeping a extended condition within said cavity (3a) when the control panel (3) is pivoted for its orientation to said horizontal position (P) for the manoeuvre.

3. The gas cooker appliance (1) with a control panel (3) according to claim 1, wherein the control panel (3) is formed with a cavity (3a) for housing the manifold assembly (2), including the regulating taps (8) and the flexible rotation transmission shafts (5), where said cavity (3a) is formed with a given housing depth (d), which together with the difference in height (E) of the pivoting shaft (6) relative to the taps (8) determines said increase in height ( H) of the control panel (3) in said horizontal position (P) for the manoeuvre.

4. The gas cooker appliance (1) with a control panel (3) according to claim 1, wherein said control panel (3) outer support wall (11) comprises a vertical wall (11) in the front of the cooker appliance (1), and the orientable control panel (3) is situated oriented vertically in a initial panel rest position.

5. The gas cooker appliance (1) with a control panel (3) according to claim 1, wherein said control panel (3) outer support wall (11) comprises a horizontal wall adjacent to the cooking surface (10), and the orientable control panel (3) is situated with a vertical orientation in the initial panel rest position.
